(19) United States
(12) Patent Application Publication
(10) Pub. No.: US 2017/0297587 A1
(43) Pub. Date: Oct. 19, 2017

(54) VEHICLE CONTROL SYSTEM, VEHICLE CONTROL METHOD, AND VEHICLE CONTROL PROGRAM

(71) Applicant: HONDA MOTOR CO., LTD., Tokyo (JP)

(72) Inventors: Yoshitaka Mimura, Wako-shi (JP); Naotaka Kumakiri, Wako-shi (JP)

(73) Assignee: HONDA MOTOR CO., LTD., Tokyo (JP)

(21) Appl. No.: 15/487,681

(22) Filed: Apr. 14, 2017

(30) Foreign Application Priority Data
Apr. 15, 2016 (JP) 2016-082218

(51) Int. Cl. B60W 50/08; B60W 10/04; B60W 40/02; G05D 1/00; B60W 10/20; B60W 30/18

(52) U.S. Cl. CPC B60W 50/082; B60W 10/20; B60W 30/18163; B60W 40/02; G05D 1/0088; B60W 10/04; B60W 2540/22; B60W 2710/20; B60W 2720/10; B60W 2420/52

(57) ABSTRACT

A vehicle control system including a driving controller, a detection section, a state prediction section, and a switching section. The driving controller controls to switch to either automated driving in which driving support is performed for at least one out of speed control or steering control of a vehicle by implementing any of plural driving modes having different levels of automated control, or manual driving performed based on operations of a driver of the vehicle on both the speed control and the steering control of the vehicle. The detection section detects a change to a surrounding environment of the driver. A state prediction section predicts a state unsuitable for the driver to drive will arise based on the change. The switching section switches the driving mode to a driving mode with a high level of automated control when the state unsuitable to drive is predicted to arise.

### CROSS REFERENCES TO RELATED APPLICATIONS

The present application claims priority under 35 U.S.C. §119 to Japanese Patent Application No. 2016-082218, filed Apr. 15, 2016, entitled “Vehicle Control System, Vehicle Control Method, and Vehicle Control Program.” The contents of this application are incorporated herein by reference in their entirety.

### BACKGROUND

### 1. Field

The present disclosure relates to a vehicle control system, a vehicle control method, and a vehicle control program.

### 2. Description of the Related Art

Recently, research is progressing into technology for performing driving support on at least one out of speed control or steering control of a vehicle (referred to as “automated driving” hereafter). In relation thereto, a driver-abnormality-time support device is known that is provided with a driver state monitoring section that monitors the state of the driver when travelling in a vehicle, a driver health determination section that determines the health of the driver based on a monitoring result from the driver state monitoring section, and a driver support section that supports the driver in accordance with a lowered degree of the health of the driver in cases in which the health of the driver has been determined to be reduced by the driver health determination section (for example, see Japanese Unexamined Patent Application Publication No. 2014-44707).

However, in conventional technology, the state of the driver is monitored directly, and driving support is performed when it has been determined that the health of the driver is reduced based on falling asleep, heart attacks, and the like. There have therefore been cases in which driving support was not enacted in time.

### SUMMARY

The present disclosure provides a vehicle control system, a vehicle control method, and a vehicle control program capable of implementing driving support in a wider range of cases.

A first aspect of the present disclosure is a vehicle control system including: a driving controller that controls to switch to either automated driving in which driving support is performed for at least one out of speed control or steering control of a vehicle by implementing any of plural driving modes having different levels of automated control, or manual driving performed based on operations of a driver of the vehicle on both the speed control and the steering control of the vehicle; a detection section that detects a change to a surrounding environment of the driver; a state prediction section that predicts a state unsuitable for the driver to drive will arise based on the change to the surrounding environment detected by the detection section; and a switching section that switches the driving mode being implemented by the driving controller to a driving mode with a high level of automated control (which performs driving assistance operations more than the driving mode implemented until the switching) in cases in which a state unsuitable for the driver to drive has been predicted to arise by the state prediction section.

A second aspect of the present disclosure is the vehicle control system of the first aspect, which may further include: an imaging section that images inside the vehicle; and an audio acquisition section that acquires sound from inside the vehicle or from outside the vehicle. Moreover, configuration may be made such that the detection section detects the change to the surrounding environment of the driver based on an image imaged by the imaging section, or audio acquired by the audio acquisition section, or both.

A third aspect of the present disclosure is the vehicle control system of the first or second aspect, wherein configuration may be made such that the state prediction section predicts a state unsuitable for the driver to drive will arise in cases in which the change in the surrounding environment is a preset condition being satisfied by a change in at least one out of a vehicle interior environment, a vehicle exterior environment, or an onboard equipment state of the vehicle.

A fourth aspect of the present disclosure is the vehicle control system of any one of the first aspect to the third aspect, wherein configuration may be made such that the switching section switches the driving mode of the vehicle to a driving mode with a low level of automated control in cases in which it has been inferred that the driver is in a posture enabling driving of the vehicle after having switched the driving mode of the vehicle to the driving mode with a high level of automated control.

A fifth aspect of the present disclosure is the vehicle control system of any one of the first aspect to the third aspect, wherein configuration may be made such that the switching section switches the driving mode of the vehicle to a driving mode with a low level of automated control when a specific time has elapsed since switching to the driving mode with a high level of automated control.

A sixth aspect of the present disclosure is the vehicle control system of any one of the first aspect to the third aspect, which may further include an operation reception section that receives an operation from the driver. Moreover, configuration may be made such that, after having switched the driving mode of the vehicle to the driving mode with a high level of automated control, the switching section switches the driving mode of the vehicle to a driving mode with a low level of automated control on receipt of an operation to switch to the driving mode with a low level of automated control from the operation reception section.

A seventh aspect of the present disclosure is the vehicle control system of any one of the first aspect to the sixth aspect, wherein configuration may be made such that the state prediction section predicts a state unsuitable for the driver to drive based on at least one out of receipt of a message for the driver, a specific operation on onboard equipment, a state of an object inside the vehicle, a state of an occupant other than the driver of the vehicle, or a state of surroundings of the vehicle.

An eighth aspect of the present disclosure is the vehicle control system of any one of the first aspect to the seventh aspect, which may further include an output section that outputs information, and an interface controller that, in cases in which a state unsuitable for the driver to drive has been predicted to arise by the state prediction section and the driving mode being implemented by the driving controller is to be switched to a driving mode with a high level of automated control, issues output to the output section regarding the switch to the driving mode with a high level of automated control.

A ninth aspect of the present disclosure is the vehicle control system of any one of the first aspect to the eighth aspect, which may further include an output section that outputs information, and an interface controller that, in cases in which a state unsuitable for the driver to drive has been predicted to arise by the state prediction section and the driving mode being implemented by the driving controller is to be switched to a driving mode with a high level of automated control, issues output to the output section stating that the switch to the driving mode with a high level of automated control is temporary.

A tenth aspect of the present disclosure is a vehicle control method, wherein an onboard computer: controls to switch to either automated driving in which driving support is performed for at least one out of speed control or steering control of a vehicle by implementing any of plural driving modes having different levels of automated control, or manual driving performed based on operations of a driver of the vehicle on both the speed control and the steering control of the vehicle; detects a change to a surrounding environment of the driver; predicts a state unsuitable for the driver to drive will arise based on the detected change to the surrounding environment; and switches the driving mode to a driving mode with a high level of automated control in cases in which a state unsuitable for the driver to drive has been predicted to arise.

An eleventh aspect of the present disclosure is a vehicle control program that causes an onboard computer to: control to switch to either automated driving in which driving support is performed for at least one out of speed control or steering control of a vehicle by implementing any of plural driving modes having different levels of automated control, or manual driving performed based on operations of a driver of the vehicle on both the speed control and the steering control of the vehicle; detect a change to a surrounding environment of the driver; predict a state unsuitable for the driver to drive will arise based on the detected change to the surrounding environment; and switch the driving mode to a driving mode with a high level of automated control in cases in which a state unsuitable for the driver to drive has been predicted to arise. It is understood and well known in the art that such program may be provided in a form of a computer program product having instructions stored in a computer readable media and readable and executable by a computer such as a vehicle control device to execute the instructions.

The present disclosure according to the first, tenth, and eleventh aspects enables driving support to be implemented in a broader range of cases based on changes to the surrounding environment of the driver inside the vehicle.

The present disclosure according to the second aspect enables changes to the surrounding environment of the driver to be detected with greater precision based on captured images, or audio, or both.

The present disclosure according to the third aspect enables changes to the surrounding environment of the driver inside the vehicle to be detected with greater precision by comparing a preset condition against changes to at least one out of the environment inside the vehicle, the environment outside the vehicle, or the onboard equipment state.

The present disclosure according to the fourth to the sixth aspects enables a switch to a driving mode with a low level of automated control at an appropriate timing.

The present disclosure according to the seventh aspect enables a state unsuitable for the driver to drive to be predicted with greater precision.

The present disclosure according to the eighth aspect enables a switch by the vehicle to a driving mode with a high level of automated control to be ascertained by the driver prior to a state unsuitable for the driver to drive arising.

The present disclosure according to the ninth aspect enables the driver to be caused to ascertain that the switch to the driving mode with a high level of automated control is temporary, and enables changes to the surrounding environment to be responded to swiftly. The word “section” used in this application may mean a physical part or component of computer hardware or any device including a controller, a processor, a memory, etc., which is particularly configured to perform functions and steps disclosed in the application.

### BRIEF DESCRIPTION OF THE DRAWINGS

FIG. 1 is a diagram illustrating configuration elements of a vehicle installed with the vehicle control system of an embodiment.

FIG. 2 is a functional configuration diagram centered on a vehicle control system.

FIG. 3 is a configuration diagram of an HMI.

FIG. 4 is a diagram illustrating a state in which a position of a vehicle relative to a travel lane is recognized by a vehicle position recognition section.

FIG. 5 is a diagram illustrating an example of an action plan generated for segments.

FIG. 6 is a diagram illustrating an example of configuration of a course generation section.

FIG. 7 is a diagram illustrating an example of candidates for a course generated by a course candidate generation section.

FIG. 8 is a diagram representing candidates for a course generated by a course candidate generation section as course points.

FIG. 9 is a diagram illustrating a lane change target position.

FIG. 10 is a diagram illustrating a speed generation model when the speeds of three surrounding vehicles are assumed to be fixed.

FIG. 11 is a diagram illustrating an example of configuration of a switch controller.

FIG. 12 is a diagram illustrating an example of data of driving switch information.

FIG. 13 is a diagram illustrating a first example of switching control based on a surrounding environment of a driver.

FIG. 14 is a diagram illustrating a second example of switching control based on a surrounding environment of a driver.

FIG. 15 is a diagram illustrating a third example of switching control based on a surrounding environment of a driver.

FIG. 16A and FIG. 16B are diagrams illustrating a fourth example of switching control based on a surrounding environment of a driver.

FIG. 17A and FIG. 17B are diagrams illustrating an example of information output to an HMI.

FIG. 18 is a flowchart illustrating an example of switching control processing.

### DESCRIPTION OF THE PREFERRED EMBODIMENTS

Explanation follows regarding embodiments of a vehicle control system, a vehicle control method, and a vehicle control program of the present disclosure, with reference to the drawings.

### Shared Configuration

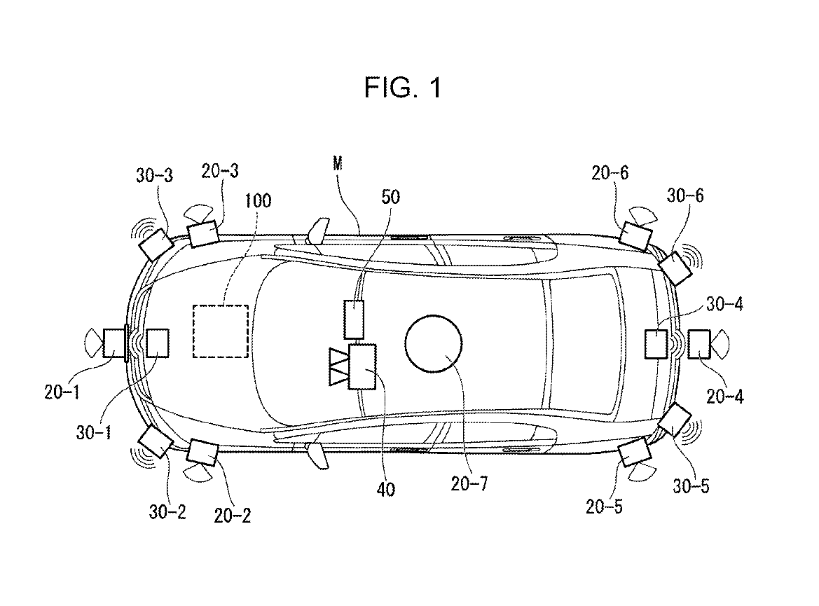

FIG. 1 is a diagram illustrating configuration elements of a vehicle referred to as the vehicle M hereafter installed with a vehicle control system 100 of the present embodiment. The vehicle installed with the vehicle control system 100 is, for example, a two-wheeled, three-wheeled, or four-wheeled automobile, and this includes automobiles that use an internal combustion engine such as a diesel engine or a gasoline engine as a power source, electric automobiles that have an electrical motor as a power source, hybrid automobiles that have both an internal combustion engine and an electrical motor, and the like. The electric automobile is, for example, driven using electric power discharged from a battery such as a secondary battery, a hydrogen fuel cell, a metal fuel cell, or an alcohol fuel cell.

As illustrated in FIG. 1, sensors such as finders 20-1 to 20-7, radars 30-1 to 30-6, and a camera (imaging section) 40, a navigation device (display section) 50, and the vehicle control system 100 are installed to the vehicle M.

The finders 20-1 to 20-7 are, for example, light detection and ranging, or laser imaging detection and ranging (LIDAR) sensors that measure scattering of illuminated light to measure the distance to a target. For example, the finder 20-1 is attached to a front grill or the like, and the finder 20-2 and the finder 20-3 are attached to a vehicle body side face, a door mirror, a front headlamp interior, a side lamp vicinity, or the like. The finder 20-4 is attached to a trunk lid or the like, the finder 20-5 and the finder 20-6 are attached to a vehicle body side face, a tail light interior, or the like. The finders 20-1 to 20-6 described above have detection regions of, for example, approximately 150° relative to a horizontal direction. The finder 20-7 is attached to a roof or the like. The finder 20-7 has a detection region of, for example, 360° relative to the horizontal direction.

The radar 30-1 and the radar 30-4 are, for example, long-range millimeter wave radars having a wider detection region in the depth direction than the other radars. The radars 30-2, 30-3, 30-5, 30-6 are intermediate-range millimeter wave radars having a narrower detection region in the depth direction than the radars 30-1 and 30-4.

Hereafter, the finders 20-1 to 20-7 are simply referred as “finders 20” in cases in which no particular distinction is made, and the radars 30-1 to 30-6 are simply referred to as “radars 30” in cases in which no particular distinction is made. The radars 30, for example, detect objects using a frequency modulated continuous wave (FM-CW) method.

The camera 40 is, for example, a digital camera that employs a solid state imaging element such as a charge coupled device (CCD) or complementary metal oxide semiconductor (CMOS). The camera 40 is attached to a front windshield upper portion, a back face of a rear-view mirror, or the like. The camera 40, for example, periodically and repeatedly images ahead of the vehicle M. The camera 40 may be a stereo camera that includes plural cameras.

Note that the configuration illustrated in FIG. 1 is merely an example; a portion of the configuration may be omitted, and other configuration may be further added.

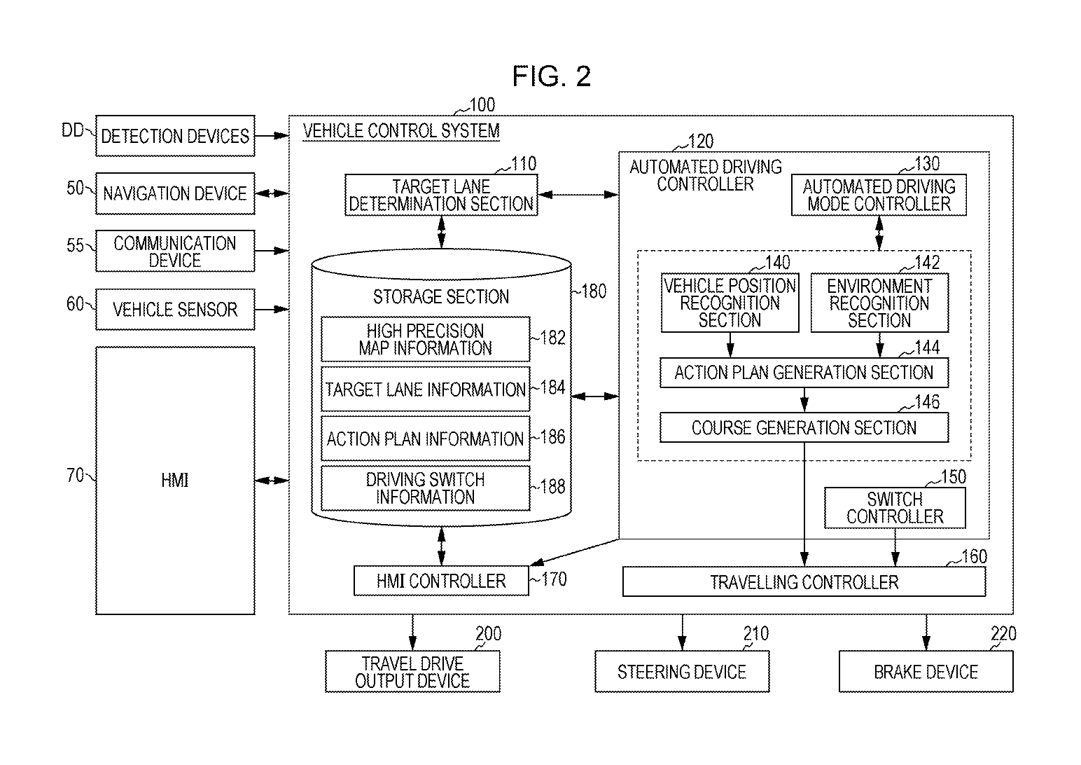

FIG. 2 is a functional configuration diagram centered on the vehicle control system 100 according an embodiment. Detection devices DD that include the finders 20, the radars 30, the camera 40, and the like, the navigation device (route guidance section, display section) 50, a communication device 55, a vehicle sensor 60, a human machine interface (HMI) 70, the vehicle control system 100, a travel drive output device 200, a steering device 210, and a brake device 220 are installed in the vehicle M. These devices and equipment are connected to one another by a multi-communication line such as a controller area network (CAN) communication line, or by a wireless communication network, a serial communication line, or the like. Note that the vehicle control system in the scope of the claims may encompass configuration (for example, at least one out of the detection devices DD, the navigation device 50, the communication device 55, the vehicle sensor 60, the HMI 70, and the like) other than that of the vehicle control system 100, and does not merely represent “the vehicle control system 100”.

The navigation device 50 includes a global navigation satellite system (GNSS) receiver, map information (a navigation map), a touch panel display device that functions as a user interface, a speaker, a microphone, and the like. The navigation device 50 infers the position of the vehicle M using the GNSS receiver and derives a route from that position to a destination designated by a vehicle occupant or the like. The route derived by the navigation device 50 is provided to a target lane determination section 110 of the vehicle control system 100. The position of the vehicle M may be inferred or complemented by an inertial navigation system (INS) employing output from the vehicle sensor 60. The navigation device 50 provides guidance along a route to the destination using audio and a navigation display. Note that configuration for inferring the position of the vehicle M may be provided independently from the navigation device 50. Moreover, the navigation device 50 may, for example, be implemented by functionality of a terminal device such as a smartphone or a tablet terminal possessed by the driver or the like of the vehicle M. In such cases, information is exchanged between the terminal device and the vehicle control system 100 using wireless or wired communication.

The communication device 55, for example, performs wireless communication using a cellular network, a Wi-Fi network, BLUETOOTH (registered trademark), dedicated short range communication (DSRC), or the like.

The vehicle sensor 60 includes a vehicle speed sensor that detects the vehicle speed, an acceleration sensor that detects acceleration, a yaw rate sensor that detects angular speed of rotation about a vertical axis, a heading sensor that detects the heading of the vehicle M, and the like.

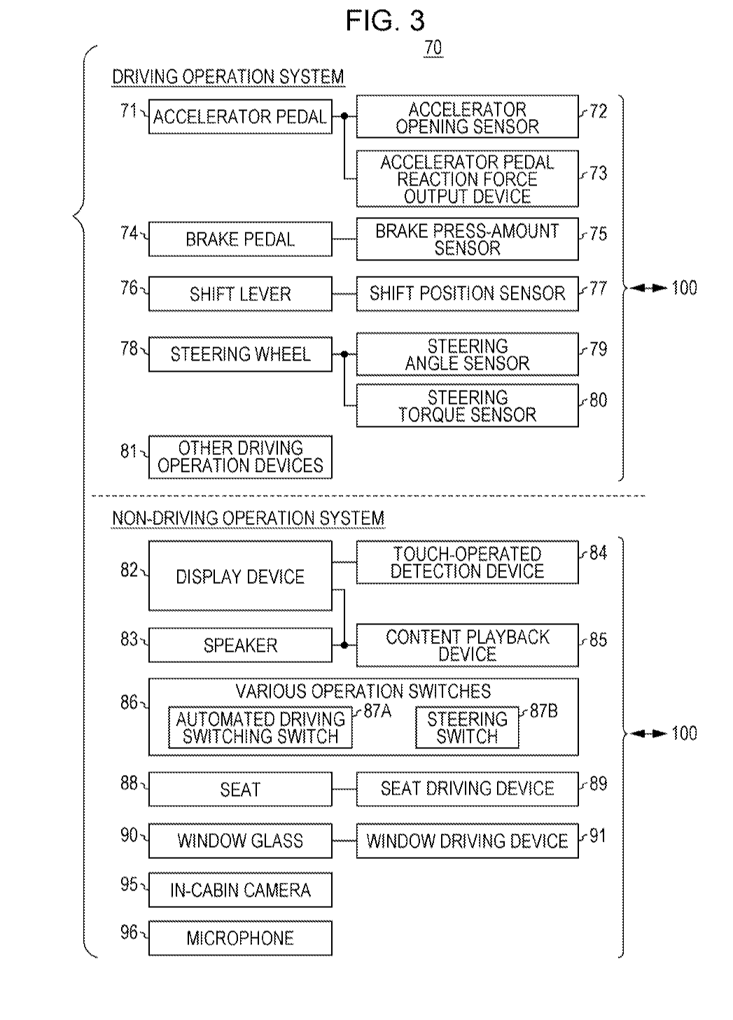

FIG. 3 is a configuration diagram of the HMI 70. The HMI 70 is provided with, for example, driving operation system configuration, and non-driving operation system configuration. There is no clear boundary between the two, and driving operation system configuration may provide non-driving operation system functionality (and vice-versa). A portion of the HMI 70 is an example of an “operation reception section” that receives an instruction or selection from the vehicle occupant of the vehicle, and a portion of the HMI 70 is an example of an “output section” that outputs information.

As configuration of the driving operation system, the HMI 70 includes, for example, an accelerator pedal 71, an accelerator opening sensor 72 and an accelerator pedal reaction force output device 73, a brake pedal 74 and a brake press-amount sensor (or a master pressure sensor or the like) 75, a shift lever 76 and a shift position sensor 77, a steering wheel 78, a steering angle sensor 79 and a steering torque sensor 80, and other driving operation devices 81.

The accelerator pedal 71 is an operation element for receiving acceleration instructions (or deceleration instructions when reverse-operated) from the vehicle occupant. The accelerator opening sensor 72 detects a press-amount of the accelerator pedal 71, and outputs an accelerator Opening signal indicating the press-amount to the vehicle control system 100. Note that output may be made directly to the travel drive output device 200, the steering device 210, or the brake device 220 instead of outputting to the vehicle control system 100. Similar applies for other configuration of the driving operation system explained below. The accelerator pedal reaction force output device 73, for example, outputs force (an operation reaction force) to the accelerator pedal 71 against the operation direction, according to instructions from the vehicle control system 100.

The brake pedal 74 is an operation element for receiving deceleration instructions from the vehicle occupant. The brake press-amount sensor 75 detects the amount of pressing (or the force of pressing) on the brake pedal 14 and outputs a brake signal indicating the detection result to the vehicle control system 100.

The shift lever 76 is an operation element for receiving shift level change instructions from the vehicle occupant. The shift position sensor 77 detects the shift level instruction by the vehicle occupant and outputs a shift position signal indicating the detection result to the vehicle control system 100.

The steering wheel 78 is an operation element for receiving turning instructions from the vehicle occupant. The steering angle sensor 79 detects the operation angle of the steering wheel 78 and outputs a steering angle signal indicating the detection result to the vehicle control system 100. The steering torque sensor 80 detects the torque placed on the steering wheel 78 and outputs a steering torque signal indicating the detection result to the vehicle control system 100.

The other driving operation devices 81 are, for example, a joystick, a button, a dial switch, a graphical user interface (GUI) switch, and the like. The other driving operation devices 81 receive acceleration instructions, deceleration instructions, turning instructions, and the like, and output the instructions to the vehicle control system 100.

As configuration of the non-driving operation system, the HMI 70 includes, for example, a display device 82, a speaker 83, a touch-operated detection device 84 and a content playback device 85, various operation switches 86, a seat 88 and a seat driving device 89, window glass 90 and a window driving device 91, an in-cabin camera (imaging section) 95, and a microphone (audio acquisition section) 96.

The display device 82 is, for example, respective sections of an instrument panel, such as a liquid crystal display (LCE) or an organic electro luminescence (EL) display device attached to, for example, freely selected locations facing the passenger seat and rear seat. For example, the display device 82 is a display positioned in front of the vehicle occupant driving the vehicle M (referred to as the “driver” hereafter where necessary). Moreover, the display device 82 may, for example, be a head-up display (HUD) that projects an image onto the front windshield or another window. The speaker 83 outputs audio. In cases in which the display device 82 is a touch panel, the touch-operated detection device 84 detects contact positions (touched positions) on the display screen of the display device 82 and outputs the contact positions to the vehicle control system 100. Note that in cases in which the display device 82 is not a touch panel, the touch-operated detection device 34 may be omitted.

The display device 82 is capable of outputting information such as images output from the navigation device 50 described above, and is capable of outputting to the navigation device 50 information from the vehicle occupant received from the touch-operated detection device 84. Note that the display device 82 may, for example, include functionality similar to the functionality of the navigation device 50 described above. The display device 82 may receive electronic mail addressed to a preset email address (for example, the email address of the driver) via the communication device 55, and may display the received content on a screen. The display device 82 may also send electronic mail created by operations by the vehicle occupant to a destination address via the communication device 55.

The content playback device 85 includes, for example, a digital versatile disc (DVD) playback device, a compact disc (CD) playback device, a television receiver, various guidance image generation devices, and the like. The content playback device 85 may, for example, play back information stored on a DVD and display a movie on the display device 82 or the like, or may play back information recorded on an audio CD and output audio from a speaker or the like. Some or all of the display device 82, the speaker 83, the touch-operated detection device 84, and the content playback device 85 described above may be configuration shared with the navigation device 50. The navigation device 50 may be included in the HMI 70.

The various operation switches 86 are disposed at freely selected places inside the vehicle cabin. The various operation switches 86 include an automated driving switching switch 87A for instructing automated driving to start (or to start in the future) or stop, and a steering switch 87B for switching output content and the like of each of the output sections of the HMI 70 (for example, the navigation device 50, the display device 82, and the content playback device 85) or the like. The automated driving switching switch 37A and the steering switch 87B may foe graphical user interface (GUI) switches, or mechanical switches. Moreover, the various operation switches 86 may include a switch for driving the seat driving device 89 or window driving device 91. Each of the various operation switches 86 outputs an operation signal to the vehicle control system 100 when an operation is received from the vehicle occupant.

The seat 88 is a seat in which the vehicle occupant sits. The seat driving device 89 freely drives the reclining angle, front-rear direction position, yaw angle, and the like of the seat 88. The window glass 90 is, for example, provided to each door. The window driving device 91 drives opening and closing of the window glass 90.

The in-cabin camera 95 is a digital camera that employs a solid state imaging element such as a CCD or CMOS. The in-cabin camera 95 captures the interior of the cabin of the vehicle M. The in-cabin camera 95 repeatedly captures at fixed periods. The in-cabin camera 95 is, for example, attached at a position where the driver, vehicle occupants other than the driver, and other space in the vehicle can be captured, such as a rearview mirror, a steering wheel boss section, or an instrument panel.

The microphone 96 acquires sounds inside the cabin of the vehicle M or outside the vehicle. The microphone 96 may be provided with a first microphone that acquires sound inside the cabin and a second microphone that acquires sound from the surroundings outside the vehicle. The microphone 96 may also acquire information related to intonation, sound levels, and the like of the acquired sound.

Prior to explaining the vehicle control system 100, explanation follows regarding the travel drive output device 200, the steering device 210, and the brake device 220.

The travel drive output device 200 outputs travelling drive force (torque) to drive wheels for causing the vehicle to travel. In cases in which the vehicle M is an automobile that has an internal combustion engine as the power source, the travel drive output device 200 includes, for example, an engine, a transmission, and an engine electronic control unit (ECU) that controls the engine. In cases in which the vehicle M is an electric automobile that has an electrical motor as the power source, the travel drive output device 200 includes, for example, a travel motor and a motor ECU that controls the travel motor. In cases in which the vehicle M is a hybrid automobile, the travel drive output device 200 includes, for example, an engine, a transmission, and an engine ECU, and a travel motor and travel motor ECU. In cases in which the travel drive output device 200 includes only an engine, the engine ECO adjusts the engine throttle opening, the shift level, or the like, in accordance with information input from a travelling controller 160, described later. In cases in which the travel drive output device 200 includes only a travel motor, the motor ECU adjusts a duty ratio of a PWM signal applied to the travel motor, in accordance with information input from the travelling controller 160. In cases in which the travel drive output device 200 includes an engine and a travel motor, the engine ECO and the motor ECU cooperatively control travelling drive force, in accordance with information input from the travelling controller 160.

The steering device 210 includes, for example, a steering ECU and an electric motor. The electric motor, for example, exerts force on a rack and pinion mechanism to change the orientation of the steering wheel. The steering ECU drives the electric motor in accordance with information input from the vehicle control system 100, or input information regarding the steering angle or steering torque, and changes the orientation of the steering wheel.

The brake device 220 is, for example, an electric servo brake device including a brake caliper, a cylinder that transmits hydraulic pressure to the brake caliper, an electric motor that causes the cylinder to generate hydraulic pressure, and a brake controller. The brake controller of the electric servo brake device controls an electric motor in accordance with information input from the travelling controller 160, such that braking torque is output to each wheel in accordance with the braking operation. The electric servo brake device may include a mechanism that transmits hydraulic pressure generated due to operation of the brake pedal to the cylinder via a master cylinder as backup. Note that the brake device 220 is not limited to the electric servo brake device explained above, and may be an electrically controlled hydraulic pressure brake device. The electrically controlled hydraulic pressure brake device controls an actuator in accordance with information input from the travelling controller 160, and transmits hydraulic pressure of a master cylinder to the cylinder. The brake device 220 may also include a regenerative brake for the travel motor that can be included in the travel drive output device 200.

### Vehicle Control System

Explanation follows regarding the vehicle control system 100. The vehicle control system 100 is, for example, implemented by one or more processors, or by hardware having equivalent functionality. The vehicle control system 100 may be configured by a combination of a processor such as a central processing unit (CPU), a storage device, and an electronic control unit (ECU) in which a communication interface is connected by an internal bus, or an micro-processing unit (MPU) or the like.

Returning to FIG. 2, the vehicle control system 100 includes, for example, the target lane determination section 110, an automated driving controller (driving controller) 120, the travelling controller 160, an HMI controller (interface controller) 170, and the storage section 180. The automated driving controller 120 includes, for example, an automated driving mode controller 130, a vehicle position recognition section 140, an environment recognition section 142, an action plan generation section 144, a course generation section 146, and a switch controller 150.

Some or all out of the target lane determination section 110, the respective sections of the automated driving controller 120, and the travelling controller 160 are implemented by the processor executing a program (software). Moreover, of these, some or all may be implemented by hardware such as a large scale integration (LSI) or an application specific integrated circuit (ASIC), or may be implemented by a combination of software and hardware.

The storage section 180 stores information such as high precision map information 182, target lane information 184, action plan information 186, and driving switch information 188. The storage section ISO is implemented by read only memory (ROM), random access memory (RAM), a hard disk drive (HDD), flash memory, or the like. The program executed by the processor may be pre-stored in the storage section 180, or may be downloaded from an external device via onboard internet equipment or the like. Moreover, the program may be installed in the storage section 180 by loading a portable storage medium storing the program into a drive device, not illustrated in the drawings. Moreover, a computer (onboard computer) of the vehicle control system 100 may be distributed across plural computer devices.

The target lane determination section 110 is, for example, implemented by an MPU. The target lane determination section 110 divides the route provided from the navigation device 50 into plural blocks (for example, divides the route every 100 m along the vehicle advance direction), and references the high precision map information 182 to determine the target lane for each block.

The target lane determination section 110 determines, for example, whether automated driving is possible on the route provided from the navigation device 50 for each of the blocks described above. For example, the target lane determination section 110 determines, forexample, which lane number from the left to travel on in segments where the vehicle M can be caused to travel in the automated driving mode by control by the automated driving controller 120. Segments where travelling by the automated driving mode is possible can, for example, be set based on positions of entrances and exits of expressways (ramps, interchanges), toll booths etc., the shape of the road (linear for a specific distance or more), and the like. Segments where travelling by the automated driving mode is possible are, for example, segments travelling on an expressway and the like; however, there is no limitation thereto.

Note that when segments where automated driving can be implemented are present over a specific distance or greater, the target lane determination section 110 may, for example, display candidates for segments where the vehicle occupant can select whether or not automated driving is required. For example, the burden of the vehicle occupant confirming whether or not automated driving is required for segments where automated driving is only possible for a short distance is thereby eliminated. Note that the processing described above may be performed by the target lane determination section 110, or may be performed by the navigation device 50.

In cases in which a branch point, a merge point, or the like is present in the route being travelled, the target lane determination section 110, for example, determines a target lane so as to enable the vehicle M to travel along a sensible travel route for advancing beyond the branch. The target lane determined by the target lane determination section 110 is stored in the storage section ISO as the target lane information 184.

The high precision map information 182 is map information with higher precision than the navigation map of the navigation device 50. The high precision map information 182 includes, for example, lane-center information, lane-boundary information, or the like. Moreover, the high precision map information 182 may include, for example, road information, traffic restriction information, address information (address, zip code) facilities information, phone number information, and the like. The road information includes information such as information indicating whether the type of road is an expressway, a toll road, a national highway, or a prefectural road, the number of lanes in the road, the width of each lane, the gradient of the road, the position of the road (three dimensional coordinates including a longitude, a latitude, and an altitude), the curvature of the lanes, the position of lane merge and branch points, and signage provided on the road. The traffic restriction information includes information regarding lane closures due to road work, traffic accidents, congestion, and the like.

When information indicating candidates for the travel route have been acquired by the navigation device 50 described above, the target lane determination section 110 references the high precision map information 182 or the like, acquires information from the automated driving controller 120 regarding segments to be travelled in the automated driving mode, and outputs the acquired information to the navigation device 50. When a route to the destination and automated driving segments have been confirmed from the navigation device 50, the target lane determination section 110 generates target lane information 184 corresponding to the route and the automated driving segments and stores the generated target lane information 184 in the storage section 180.

The automated driving controller 120, for example, performs driving support on at least one of speed control or steering control of the vehicle by implementing one of plural driving modes with different levels of automated control. Note that speed control is, for example, control related to acceleration/deceleration of the vehicle M, and includes one or both out of acceleration or deceleration in acceleration/deceleration. The automated driving controller 120 controls manual driving performed based on operations by the driver of the vehicle M on both speed control and steering control of the vehicle M, based on operations and the like received by an operation reception section such as the HMI 70.

The automated driving mode controller 130 determines the automated driving mode to be implemented by the automated driving controller 120. The automated driving mode in the present embodiment includes the following modes. Note that the following modes are merely examples and the number of modes of the automated driving may be freely determined.

### Mode A

Mode A is the mode in which the level of automated control is highest. In cases in which the mode A is being implemented, all vehicle controls, such as complex merging control, are performed automatically, such that the vehicle occupant does not need to monitor the surroundings or state of the vehicle M.

### Mode B

Mode B is a mode of the next highest level of automated control after the mode A. Although in principle all vehicle control is performed automatically in cases in which the mode B is implemented, the driving operation of the vehicle M is entrusted to the vehicle occupant depending on the situation. The vehicle occupant therefore needs to monitor the surroundings and state of the vehicle M.

### Mode C

The mode C is a mode having the next highest level of automated control after mode B. In cases in which mode C is implemented, the vehicle occupant needs to perform confirmation operations on the HMI 70 depending on the situation. Mode C, for example, notifies a lane change timing to the vehicle occupant, and automatically makes the lane change in cases in which the vehicle occupant has performed an operation on the HMI 70 instructing a lane change. The vehicle occupant therefore needs to monitor the surroundings and state of the vehicle M. Note that in the present embodiment, the mode with the lowest level of automated control may, for example, be a manual driving mode in which, for example, both speed control and steering control of the vehicle M are performed based on operation by the driver of the vehicle M without automated driving being performed.

The automated driving mode controller 130 determines the automated driving mode based on operation on the HMI 70 by the vehicle occupant, events determined by the action plan generation section 144, travelling conditions determined by the course generation section 146, and the like. The automated driving mode is notified to HMI controller 170. Moreover, a limit that depends on the performance or the like of the detection devices DD of the vehicle M may be set on the automated driving mode. For example, configuration may foe such that mode A is not implemented in cases in which the performance of the detection devices DD is low. Switching to the manual driving mode (override) by operating the configuration of the driving operation system in the HMI 70 is possible for all of the modes.

The vehicle position recognition section 140 recognizes the lane in which the vehicle M is travelling (the travel lane) and the position of the vehicle M relative to the travel lane, based on the high precision map information 182 stored in the storage section 180, and the information input from the finders 20, the radars 30, the camera 40, the navigation device 50, or the vehicle sensor 60.

The vehicle position recognition section 140, for example, recognizes the travel lane by comparing a road demarcation line pattern recognized from the high precision map information 182 (for example, an arrangement of solid lines or dashed lines) against a road demarcation line pattern of the surroundings of the vehicle M recognized from the images imaged using the camera 40. In the recognition, the position of the vehicle M acquired from the navigation device 50, or the processing result by the INS, may be taken into account.

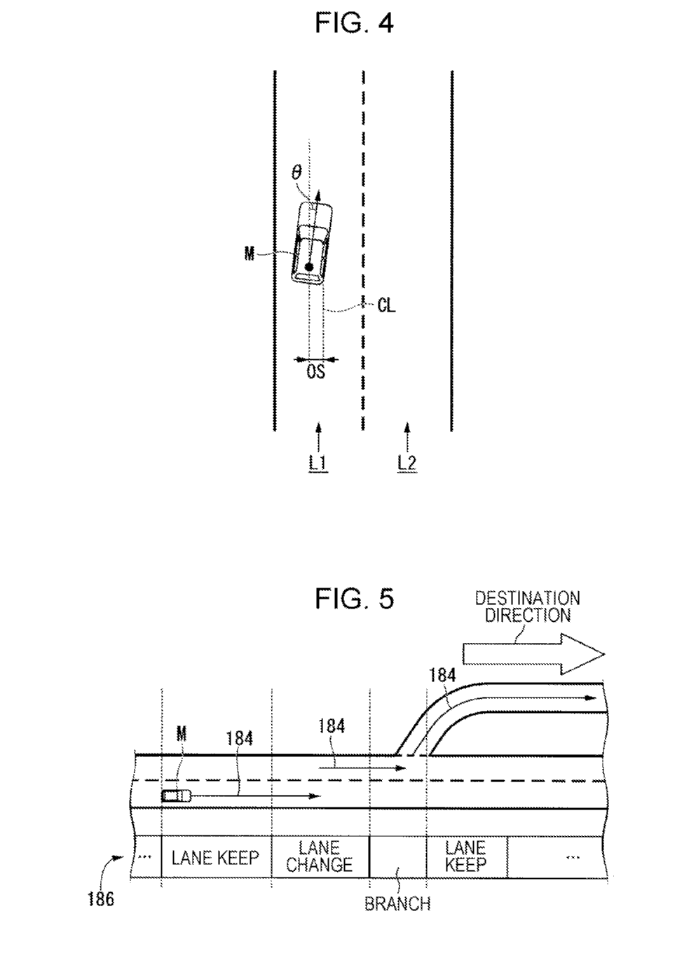

FIG. 4 is a diagram illustrating a state in which the relative position of the vehicle M with respect to a travel lane L1 is recognized by the vehicle position recognition section 140. The vehicle position recognition section 140 recognizes, for example, an offset OS between a reference point (for example, the center of mass) of the vehicle M and a travel lane center CL, and recognizes an angle θ formed between the advance direction of the vehicle M and a line aligned with the travel lane center CL as the relative position of the vehicle M with respect to the travel lane L1. Note that, alternatively, the vehicle position recognition section 140 may recognize the position of the reference point of the vehicle M or the like with respect to either of the side end portions of the vehicle lane L1 as the relative position of the vehicle M with respect to the travel lane. The relative position of the vehicle M recognized by the vehicle position recognition section 140 is provided to the target lane determination section 110.

The environment recognition section 142 recognizes the position, speed, and acceleration states of surrounding vehicles based on the information input from the finders 20, the radars 30, the camera 40, and the like. Surrounding vehicles are, for example, vehicles that are travelling in the surroundings of the vehicle M and that are travelling in the same direction as the vehicle M. The positions of the surrounding vehicles may be presented as representative points such as centers of mass or corners of other vehicles, or may be represented as regions represented by the wheels of the other vehicles. The “state” of a surrounding vehicle may include whether or not the surrounding vehicle is accelerating or changing lanes (or whether or not the surrounding vehicle is attempting to change lanes), as ascertained based on the information of the various equipment described above. Moreover, the environment recognition section 142 may recognize the position of a guard rail, a utility pole, a parked vehicle, a pedestrian, a fallen object, a railway crossing, traffic signals, signage placed in the vicinity of a construction site or the like, and other objects, in addition to the surrounding vehicles.

The action plan generation section 144 sets a starting point of automated driving and/or a destination of automated driving. The starting point of automated driving may be the current position of the vehicle M, or may be a point set by operation to instruct automated driving. The action plan generation section 144 generates an action plan in the segments between the starting point and the destination of automated driving. Note that there is no limitation thereto, and the action plan generation section 144 may generate an action plan for freely selected segments.

The action plan is, for example, composed of plural events to be sequentially executed. The events include, for example, a deceleration event that decelerates the vehicle M, an acceleration event that accelerates the vehicle M, a lane-keep event that causes the vehicle M to travel without departing from the travel lane, a lane-change event that causes the travel lane to change, an overtake event that causes the vehicle M to overtake the vehicle in front, a branch event that causes a lane change to the desired lane at a branch point or causes the vehicle M to travel so as not to depart from the current travel lane, a merge event that causes the vehicle M to accelerate or decelerate in a merging lane for merging with a main lane and changes the travel lane, and a handover event that causes a transition from manual driving mode to automated driving mode at a start point of automated driving or causes a transition from automated driving mode to manual driving mode at a point where automated driving is expected to end.

The action plan generation section 144 sets a lane-change event, a branch event, or a merge event at places where the target lane determined by the target lane determination section 110 switches. Information indicating the action plan generated by the action plan generation section 144 is stored in the storage section 180 as the action plan information 186.

FIG. 5 is a diagram illustrating an example of the action plan generated for a given segment. As illustrated in FIG. 5, the action plan generation section 144 generates the action plan needed for the vehicle M to travel on the target lane indicated by the target lane information 184. Note that the action plan generation section 144 may dynamically change the action plan irrespective of the target lane information 184, in accordance with changes to the situation of the vehicle M. For example, in cases in which the speed of a surrounding vehicle recognized by the environment recognition section 142 during vehicle travel exceeds a threshold value, or the movement direction of a surrounding vehicle travelling in a lane adjacent to the vehicle lane is toward the vehicle lane direction, the action plan generation section 144 changes the event set in the driving segment that the vehicle M is expected to travel. For example, in cases in which an event is set such that a lane-change event is to be executed after a lane-keep event, when it has been determined by the recognition result of the environment recognition section 142 that a vehicle is advancing at a speed of the threshold value or greater from the rear of the lane change target lane during the lane-keep event, the action plan generation section 144 may change the event following the lane-keep event from a lane-change event to a deceleration event, a lane-keep event, or the like. As a result, the vehicle control system 100 can cause the vehicle M to self-travel safely even in cases in which a change occurs to the state of the environment.

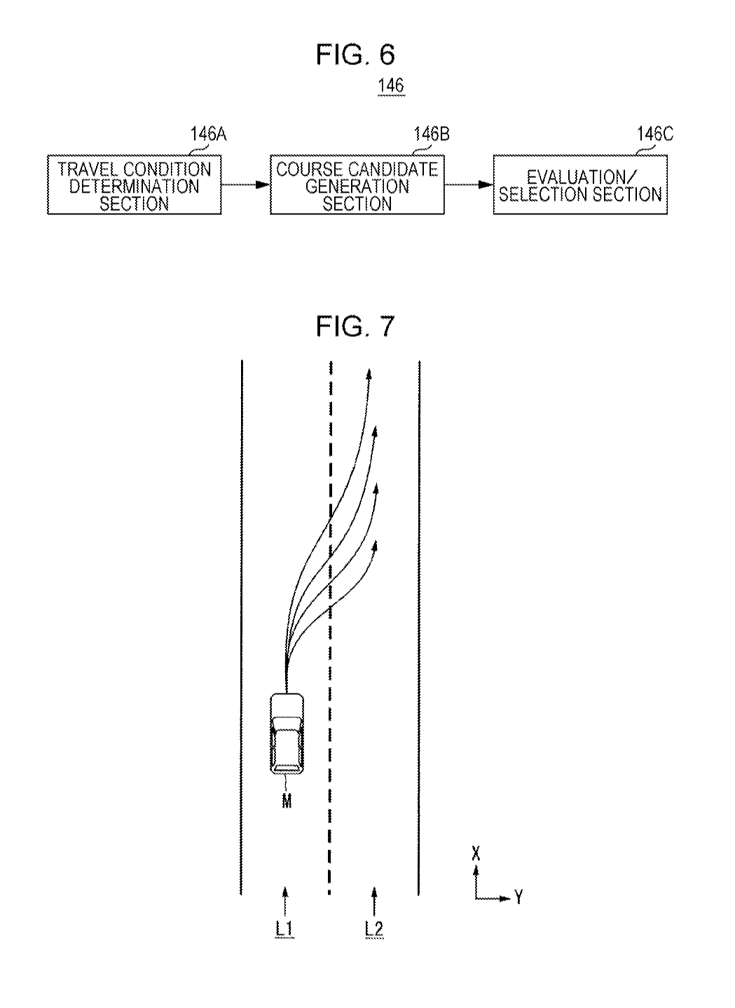

FIG. 6 is a diagram illustrating an example of the configuration of the course generation section 146. The course generation section 146 includes, for example, a travel condition determination section 146A, a course candidate generation section 146B, and an evaluation/selection section 146C.

When implementing a lane-keep event, the travel condition determination section 146A, for example, determines a travel condition from out of fixed speed travel, following-travel, low speed following-travel, deceleration travel, curve travel, obstacle avoidance travel, or the like. For example, the travel condition determination section 146A determines that the travel condition is fixed speed travel when no other vehicles are present ahead of the vehicle M. The travel condition determination section 146A determines that the travel condition is following-travel in cases such as travel following a vehicle in front. The travel condition determination section 146A determines that the travel condition is low speed following-travel in a congested situation of the like. The travel condition determination section 146A determines that the travel condition is deceleration travel in cases in which deceleration of the vehicle in front is recognized by the environment recognition section 142, and in cases in which an event for, for example, stopping or parking is implemented. The travel condition determination section 146A determines that the travel condition is curve travel in cases in which the environment recognition section 142 recognizes that the vehicle M has come to a curve. The travel condition determination section 146A determines that the travel condition is obstacle avoidance travel in cases in which the environment recognition section 142 has recognized an obstacle in front of the vehicle M.

The course candidate generation section 146B generates candidates for the course based on the travel condition determined by the travel condition determination section 146A. FIG. 7 is a diagram illustrating an example of candidates for the course generated by the course candidate generation section 146B. FIG. 7 illustrates candidates for the generated course when the vehicle M changes lanes from a lane L1 to a lane L2.

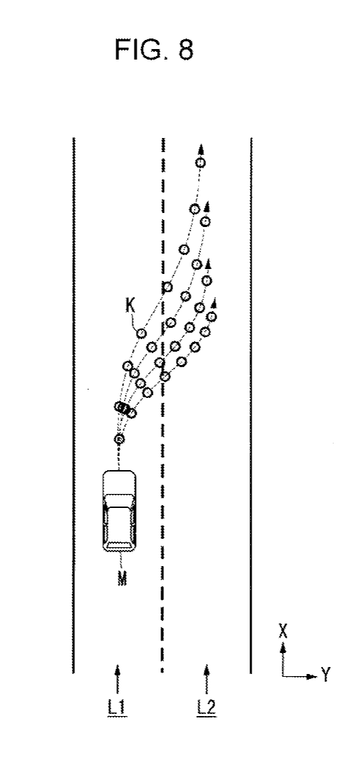

The course candidate generation section 146B, for example, determines courses like that illustrated in FIG. 7 as a collection of a target position (course points K) for each specific time interval in the future where the reference position (for example, the center of mass or rear wheel axle center) of the vehicle M is to arrive. FIG. 8 is a diagram illustrating candidates for the course generated by the course candidate generation section 146B, represented by course points K. The wider the separations between course points K, the faster the speed of the vehicle M, and the narrower the separations between course points K, the slower the speed of the vehicle M. Accordingly, the course candidate generation section 146B gradually widens the separations between the course points K when acceleration is desired, and gradually narrows the separations between the course points when deceleration is desired.

Thus, the course candidate generation section 146B needs to apply a target speed to each course point K since the course points K include a speed component. The target speed is determined in accordance with the travel condition determined by the travel condition determination section 146A.

Here, explanation follows regarding a determination method for the target speed when lane changing (branches included) is performed. The course candidate generation section 146B first sets a lane change target position (or a merge target position). The lane change target position is set as a position relative to surrounding vehicles, and determines “which surrounding vehicles to change lanes between”. The course candidate generation section 146B observes three surrounding vehicles as references for the lane change target position, and determines a target speed when performing the lane change.

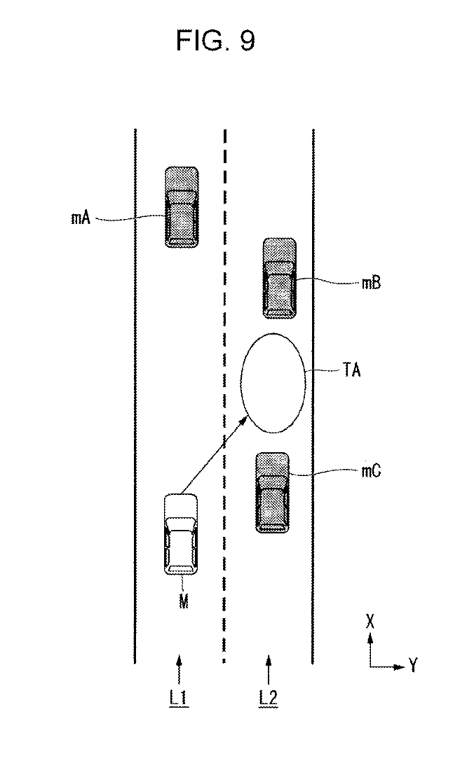

FIG. 3 is a diagram illustrating a lane change target position TA. In FIG. 9, L1 represents the lane of the vehicle, and L2 represents an adjacent lane. Here, a vehicle in front mA is defined as a surrounding vehicle travelling directly in front of the vehicle M in the same lane as the vehicle M, a forward reference vehicle mB is defined as a surrounding vehicle travelling directly in front of the lane change target position TA, and a rear reference vehicle mC is defined as a surrounding vehicle travelling directly behind the lane change target position TA. The vehicle M needs to accelerate or decelerate to move to beside the lane change target position TA, but must avoid tailgating the vehicle in front mA at this time. The course candidate generation section 146B therefore predicts the future state of the three surrounding vehicles and determines a target speed that will not cause interference with any of the surrounding vehicles.

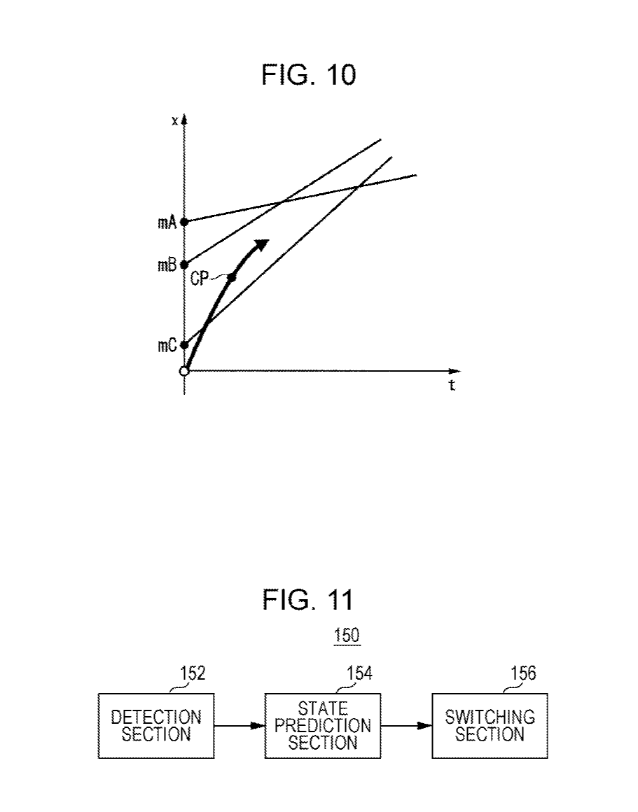

FIG. 10 is a diagram illustrating a speed generation model when the speed of the three surrounding vehicles is assumed to be constant. In this figure, the straight lines extending from mA, mB, and mC each represent a displacement in the direction of advance when the surrounding vehicles are assumed to be travelling at respective fixed speeds. At a point GP where the lane change finishes, the vehicle M must be between the forward reference vehicle mB and the rear reference vehicle mC, and up to that point must be behind the vehicle in front mA. Under such restrictions, the course candidate generation section 146B derives plural time series patterns of target speeds up to when the lane change finishes. Then, the time series patterns of target speeds is applied to a model such as a spline curve to derive plural candidates for the course as illustrated in FIG. 7, described above. Note that the movement pattern of the three surrounding vehicles may be predicted under the assumption of constant acceleration or constant jerk (surge), irrespective of the fixed speed as illustrated in FIG. 10.

The evaluation/selection section 146C evaluates, for example, the candidates for the course generated by the course candidate generation section 146B from the two viewpoints of plan quality and safety, and selects a course to be output to the travelling controller 160. From the viewpoint of plan quality, courses are evaluated highly in cases in which, for example, an already generated plan (for example, an action plan) is followed well and the total length of the course is short. For example, in cases in which a lane change in the rightward direction is desired, courses that temporarily change lanes in the leftward direction and then return have a low evaluation. From the viewpoint of safety, for example, at each course point, the further the distance between the vehicle M and objects (such as surrounding vehicles) and the smaller the amount of change in acceleration/deceleration, steering angle, or the like, the higher the evaluation.

The switch controller 150, for example, switches between the automated driving mode and the manual driving mode based on the signal input from the automated driving switching switch 87A. From changes in the surrounding environment of the driver and the vehicle M, the switch controller 150 predicts a state unsuitable for the driver to drive will arise. Note that a state unsuitable for driving is a state in which, for example, driver distractions appear. Driver distractions, for example, are actions other than driving that distract the attention of the driver of the vehicle M.

The switch controller 150 performs control to switch the driving mode of the vehicle M to a driving mode with a high level of automated control when, during manual driving, it has been predicted that a state unsuitable for the driver of the vehicle M to drive will arise. Note that when a specific condition has been satisfied after switching the driving mode to a driving mode with a high level of automated control, the switch controller ISO may perform control to return (switch) to a driving mode with a low level of automated control.

FIG. 11 is a diagram illustrating an example of configuration of the switch controller 150. The switch controller 150 includes, for example, a detection section 152, a state prediction section 154, and a switching section 156. The detection section 152 detects changes to the surrounding environment of the driver of the vehicle M based on information and the like obtained from each piece of equipment of the non-driving operation system of the HMI 70. Here, a change to the surrounding environment of the driver is, for example, a change in at least one out of the in-cabin environment (for example, an environment inferred from information obtained by the in-cabin camera 95 or the microphone 96), a vehicle-outside environment (for example, an environment inferred from information obtained by the detection devices DD or the microphone 96), or a state of onboard equipment (for example, the non-driving operation system of the HMI 70). For example, the detection section 152 detects changes to the surrounding environment of the driver based on at least one out of images captured by the in-cabin camera 95, images captured by the camera 40 of the detection devices DD, or audio acquired by the microphone 96 or the like.

The state prediction section 154 predicts that a state unsuitable for the driver to drive will arise based oh the changes to the surrounding environment of the driver detected by the detection section 152. For example, the state prediction section 154 predicts that a state unsuitable for the driver of the vehicle M to drive will arise based on whether or not the in-cabin environment, vehicle-outside environment, onboard equipment state, or the like detected by the detection section 152 satisfies a condition of the driving switch information 188 pre-stored in the storage section 180. The state prediction section 154 predicts that a state unsuitable for the driver of the vehicle M to drive will arise based on at least one out of arrival of electronic mail for the driver of the vehicle M, a specific operation on the HMI (onboard equipment) 70, the state of an object inside the vehicle, the state of a vehicle occupant other than the vehicle occupant driving the vehicle, and the state of the surroundings of the vehicle M. In cases in which the state prediction section 154 has predicted a state unsuitable for the driver of the vehicle M to drive, the state prediction section 154 instructs the switching section 156 to switch the driving mode of the vehicle M to a driving mode with a high level of automated control. A switch to a driving mode with a high level of automated control is, for example, a switch to the automated driving mode in cases in which the driving mode is the manual driving mode; however, there is no limitation thereto, and a switch may be made from mode C or mode B of automated driving to mode A.

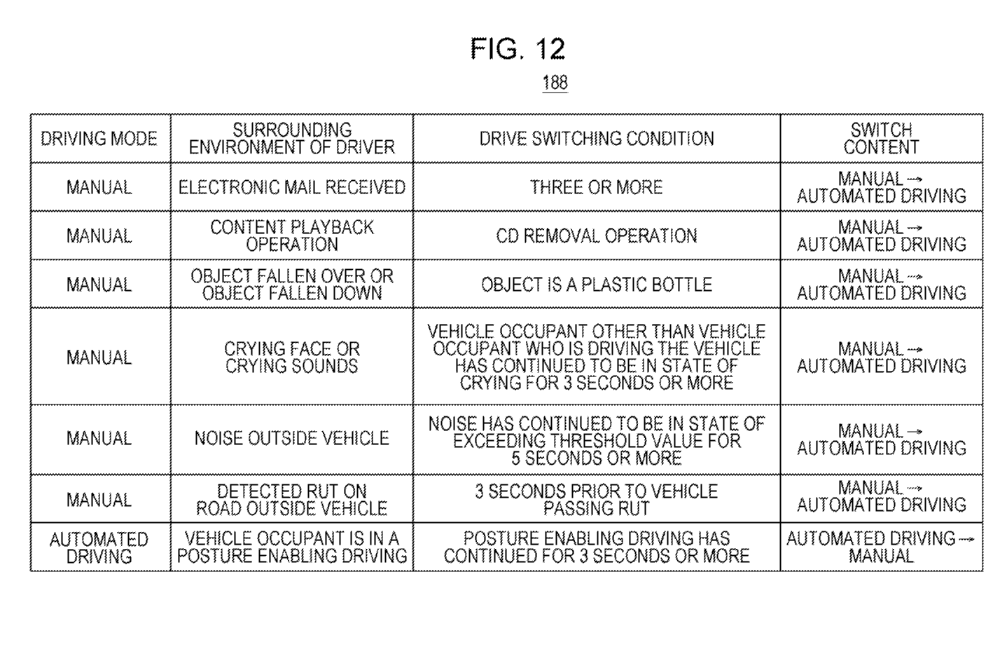

FIG. 12 is a diagram illustrating an example of data of the driving switch information 188. For example, a “driving mode”, a “surrounding environment of driver”, a “drive switching condition”, a “switch content” and the like serve as items of the driving switch information 188 illustrated in FIG. 12. The “driving mode” is the driving mode of the vehicle M at the current point in time (the point in time when the prediction is made by the state prediction section 154). The “surrounding environment of driver” is the content of the change to the surrounding environment of the driver of the vehicle M detected by the detection section 152. Note that the “surrounding environment of driver” may include the situation of the vehicle cabin or outside the vehicle (the surroundings of the vehicle M). The “drive switching condition” is set as a condition (threshold value) serving as a basis for switching the driving mode in accordance with the type of “surrounding environment of driver”. The “switch content” is set with content of the switch in the current driving mode.

When the state prediction section 154 has predicted that a state unsuitable for the driver of the vehicle M to drive will arise, the switching section 156 switches the driving mode implemented by the automated driving controller 120 to a driving mode with a high level of automated control.

Next, explanation follows regarding switching control based on the surrounding environment of the driver (the vehicle situation) of the present embodiment, with reference to the drawings. In the following explanation, redundant explanation is omitted from each example as appropriate.

### First Example of Switching Control

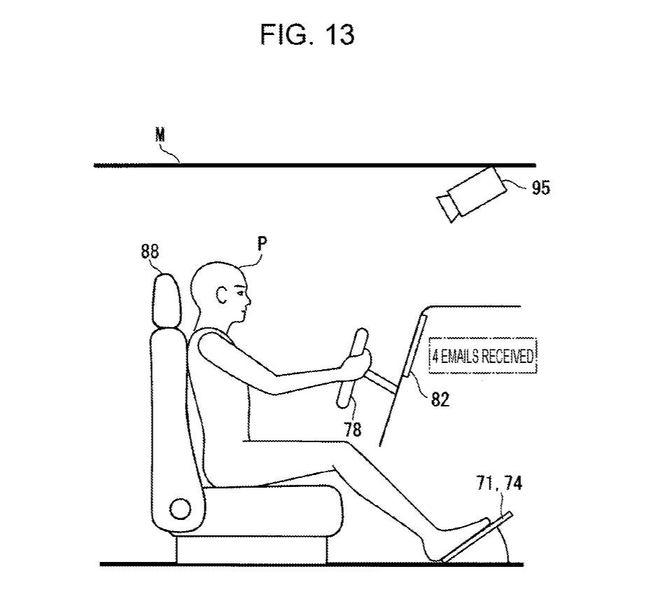

FIG. 13 is a diagram illustrating a first example of switching control based on the surrounding environment of the driver. In the first example, an example is given in which the driving mode of the vehicle M switches to a driving mode with a high level of automated control (for example, from the manual driving mode to an automated driving mode) when electronic mail has arrived at the email address of the driver of the vehicle M.

In the example of FIG. 13, a driver P is seated in the seat 88 of the vehicle M. The driver P is a vehicle occupant driving (manually driving) the vehicle M, and a vehicle occupant other than the driver P may also foe seated in the passenger seat or in a rear seat in the vehicle M. The driver P can manually drive the vehicle M by rotating the steering wheel 78, and by operations such as pressing the accelerator pedal 71 or brake pedal 74.

Here, for example, in cases in which the vehicle M is in manual driving mode, when the detection section 152 has detected that the display device 82 has received an electronic mail, the detection section 152 outputs the detection result to the state prediction section 154. Note that the fact that an electronic mail was received in the display device 82 and the content of received electronic mail may, for example, be detected by the HMI controller 170 that controls the display device 82, and notified to the detection section 152.

Based on the detection result by the detection section 152, the state prediction section 154 references the driving switch information 188 described above and acquires a driving switch condition corresponding to the driving mode (manual) and the surrounding environment of the driver (electronic mail received). Here, since the number of received items in the example of FIG. 13 is 4, compared with a number of received electronic mails of 3 or more in the driving switch information 188, the drive switching condition is satisfied. In such cases, it is predicted that a state unsuitable for the driver of the vehicle M to drive will arise due to the high possibility of the received email attracting the attention of the driver. Accordingly, the state prediction section 154 outputs information indicating a switch from manual driving to automated driving (a switch instruction) to the switching section 156. Note that when the number of received emails is, for example, 2, the state prediction section 154 does not instruct the switching section 156 to switch since the drive switching condition is not satisfied.

Based on the instruction from the state prediction section 154, the switching section 156 implements control to switch the driving mode of the vehicle M from the manual driving mode to the automated driving mode, and outputs information indicating the switch from manual driving mode to automated driving mode to the HMI controller 170.

In the first example described above, the state prediction section 154 determines whether or not driving will switch based on the content and type of the received electronic mail. For example, in cases in which a received electronic mail is disaster information such as an earthquake early warning, the state prediction section 154 issues a switching instruction to the switching section 156 irrespective of a received count or the like set in the driving switch information 188 described above. Although receipt of electronic mail for the driver served as the surrounding environment of the driver in the first example, there is no limitation thereto. For example, the surrounding environment of the driver may fee general message receipt for the driver, such as receipt of a telephone call, or receipt of a notification from the display device 82 or from an application installed to a terminal device possessed by the driver or the like.

### Second Example of Switching Control

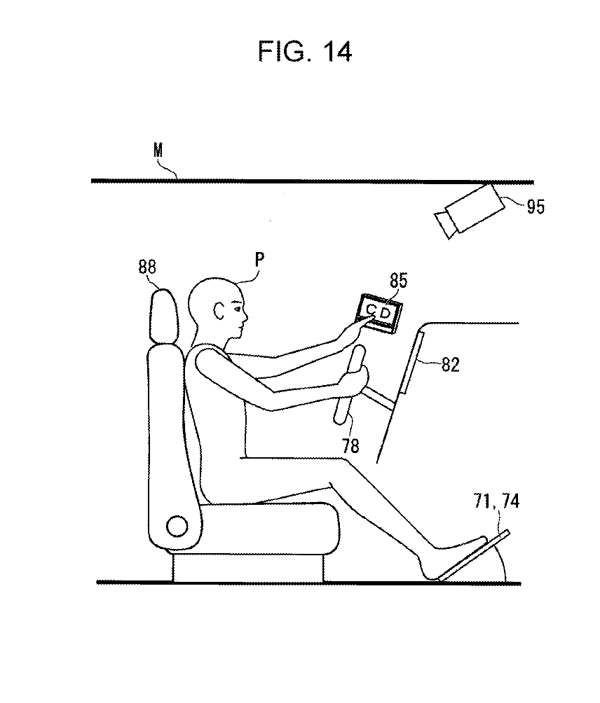

FIG. 14 is a diagram illustrating a second example of switching control based on the surrounding environment of the driver. In the second example, an example is given in which the driving mode of the vehicle M switches to a driving mode with a high level of automated control (for example, from a manual driving mode to an automated driving mode) in cases in which it has been predicted that the driver P of the vehicle M is operating the content playback device 85 installed in the vehicle M.

For example, when the vehicle M is in the manual driving mode, the detection section 152 detects that the driver P is in a state of operating the content playback device 85, by analyzing, from an image captured by the in-cabin camera 95, the position of the left hand of the driver P as illustrated in FIG. 14, text at the top of a screen of the content playback device 85, the shape of a CD, or the like. Note that the detection section 152 may detect that the driver P is in a state of operating the content playback device 85 in cases in which the content playback device 35 has received operation content. The detection section 152 outputs information indicating that the driver P is in a state of operating the content playback device 85 to the state prediction section 154.

Based on the detection result by the detection section 152, the state prediction section 154 references the driving switch information 188 described above and acquires the drive switching condition corresponding to the driving mode (manual) and surrounding environment of the driver P (content playback operation). Here, a simple playback operation for an audio CD is being performed in the example of FIG. 14, rather than the “CD removal operation” of the driving switch information 188. In such cases, the state prediction section 154 does not output any information to the switching section 156 and does not switch from the manual driving mode to the automated driving mode, since the possibility of a driver distraction occurring is low.

Moreover, the detection section 152 detects that the CD is in a removed state in cases in which the operation content received by the content playback device 85 is “remove CD” and in cases in which a CD shape is present in the captured image in-cabin camera 95. The detection result satisfies the drive switching condition in the driving switch information 188 (a CD removal operation). In such cases, it is predicted that a state unsuitable for the driver of the vehicle M to drive will arise since the possibility of the CD replacement operation attracting the attention of the driver is high. Accordingly, the state prediction section 154 outputs to the switching section 156 information (a switch instruction) indicating that a switch is to be made from the manual driving mode to the automated driving mode, before a state unsuitable for the driver P of the vehicle M to drive arises.

The switching section 156 implements control to switch the driving mode of the vehicle M from the manual driving mode to the automated driving mode based on the instruction from the state prediction section 154, and outputs to the HMI controller 170 information indicating the switch from the manual driving mode to the automated driving mode.

### Third Example of Switching Control

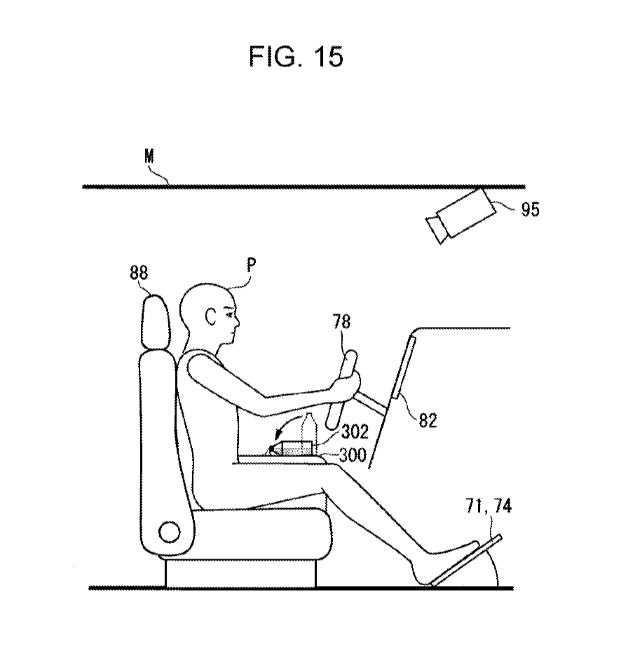

FIG. 15 is a diagram illustrating a third example of switching control based on the surrounding environment of the driver. In the third example, an example is given in which the driving mode of the vehicle M switches to a driving mode with a high level of automated control (for example, from the manual driving mode to the automated driving mode) in cases in which a specific object inside the vehicle M falls over or fails down.

For example, in cases in which the vehicle M is in the manual driving mode, the detection section 152 detects, from images captured by the in-cabin camera 95, that an object placed on a platform 300 inside the cabin as illustrated in FIG. 15 (for example, a plastic bottle 302) has fallen over due to vibrations and swaying of the vehicle M. In the third example, the detection section 152 identifies a type (for example, plastic bottle 302) or the like of an object based on feature information such as shapes and colors of preset objects, from images captured by the in-cabin camera 95. The detection section 152 outputs information related to the detection result to the state prediction section 154 in cases in which it has been detected that the identified object has fallen over or that the object has fallen down from the platform 300, from amounts of movement, movement direction, shape after moving, and the like of the object in each unit of time.

The state prediction section 154 references the driving switch information 188 described above, and acquires the drive switching condition corresponding to the driving mode (manual) and surrounding environment of the driver F (the object has fallen over or the object has fallen down), based on the detection result by the detection section 152. Here, in the driving switch information 188, the drive switching condition is satisfied in the example of FIG. 15 since the object is a plastic bottle and the plastic bottle 302 has fallen over with the cap removed. In such cases, since liquid inside the plastic bottle 302 spills out, it is predicted that a state unsuitable for the driver P to drive will arise since there is a high possibility that the attention of the driver P will be attracted by the plastic bottle 302. Accordingly, the state prediction section 154 outputs an instruction to the switching section 156 to switch from the manual driving mode to the automated driving mode before a state unsuitable for the driver P of the vehicle M to drive arises. Note that in the third example, the state prediction section 154 does not issue a switching instruction to the switching section 156 in cases other than when the object is a plastic bottle 302 since the drive switching condition is not satisfied; however, control can be made to issue a switching instruction for other objects also by adding conditions for other objects to the driving switch information 188 in advance.

The switching section 156 implements control to switch the driving mode of the vehicle M from the manual driving mode to the automated driving mode based on the instruction from the state prediction section 154, and outputs to the HMI controller 170 information indicating the switch from the manual driving mode to the automated driving mode.

### Fourth Example of Switching Control

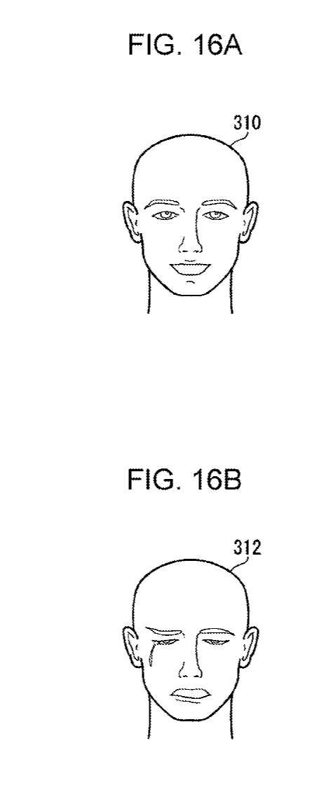

FIG. 16A and FIG. 16B are diagrams illustrating a fourth example of the switching control based on the surrounding environment of the driver. In the fourth example, an example is given in which the driving mode of the vehicle M switches to a driving mode with a high level of automated control (for example, from the manual driving mode to the automated driving mode) based on the state of an occupant (for example, a child) other than the driver of the vehicle M.

For example, when the vehicle M is in the manual driving mode, the detection section 152 acquires an image of the face of the vehicle occupant of the vehicle M from images captured by the in-cabin camera 95. Note that a face image may, for example, be acquired from a captured image based on facial feature information including shapes, positions, and the like of respective parts such as the eyes, nose and mouth of the image of the face. Moreover, the detection section 152 may acquire plural identifiable face images from one captured image. The driver P (an example of a vehicle occupant) of the vehicle M can be distinguished from vehicle occupants other than the driver (vehicle occupants that are not driving) based on the position of the face in the image.

The detection section 152 detects the expression on the face from the acquired face image and outputs a detection result to the state prediction section 154. The expression of the face can be inferred from the shape or the like of the respective parts. For example, the expression is inferred as a “smiling face” for the face image 310 illustrated in FIG. 16A. The expression is inferred as a “crying face” for the face image 312 illustrated in FIG. 16B. The detection section 152 may continuously infer the expression as described above and may output the detection result for the expression obtained from the inference to the state prediction section 154.

The detection section 152 may detect that the vehicle occupant in the vehicle M is in a crying state in cases in which it has been detected that the audio in the vehicle M acquired by the microphone 96 or the like includes crying sounds. Note that crying sounds may be detected based on, for example, intonation of the audio, the amount of noise, and the like. The detection section 152 may infer whether the crying sounds are those of the driver P of the vehicle M or crying sounds of a vehicle occupant who is not driving by inferring which direction or the crying sounds are heard from with respect to a fixed installation position of the microphone 96.

The state prediction section 154 references the driving switch information 188 described above and acquires the drive switching condition corresponding to the driving mode (manual) and surrounding environment of the driver P (crying face or crying sounds), based on the detection result by the detection section 152. Here, in the driving switch information 188, the driving mode of the vehicle M is set to switch from the manual driving mode to the automated driving mode in cases in which a vehicle occupant who is not the driver of the vehicle M continues to be in a crying state for 3 seconds or longer.

For example, when the expression of the vehicle occupant who is not driving the vehicle M is an expression of a “smiling face” as illustrated in FIG. 16A, the state prediction section 154 does not issue a switching instruction to the switching section 156 since the state prediction section 154 does not satisfy the drive switching condition. When the expression of the vehicle occupant who is not driving the vehicle M is an expression of a “crying face” as illustrated in FIG. 16B, the state prediction section 154 satisfies the drive switching condition in cases in which this state continues for 3 seconds or more. In such cases, it is predicted that a state unsuitable for the driver P of the vehicle M to drive will arise since the possibility of the attention of the driver P of the vehicle M being attracted by the crying vehicle occupant is high. Accordingly, the state prediction section 154 outputs to the switching section 156 an instruction to switch the driving mode of the vehicle M from the manual driving mode to an automated driving mode, prior to a state unsuitable for the driver of the vehicle M to drive arising.

The switching section 156 implements control to switch the driving mode of the vehicle M from the manual driving mode to the automated driving mode based on the instruction from the state prediction section 154, and outputs to the HMI controller 170 information regarding the switch from the manual driving to the automated driving. Note that conditions, numeric values, and the like for switching the driving mode of the vehicle M from the manual driving mode to the automated driving mode are not limited to the example of FIG. 12. For example, conditions in which it is predicted that driver distractions will occur may be included.

For example, as illustrated in FIG. 12, when the loudness (volume) of sound (noise) in the surroundings of the vehicle M collected by the microphone 96 is detected and a state of the volume of the noise detected from outside the vehicle exceeding a threshold value continues for 5 seconds or more, there is a high possibility that the driver of the vehicle M will turn in the direction of the noise and that the attention of the driver of the vehicle M will be attracted. The state prediction section 154 may therefore predict a state unsuitable for the driver to drive will arise in the case of the state described above. Moreover, for example, when there is a rut in the road or when the road is poor quality or the like, there is a possibility that the posture of the driver of the vehicle M will be altered due to the road conditions. The state prediction section 154 may therefore predict that a state unsuitable for the driver of the vehicle M to drive will arise due to the road conditions when a rut in the road outside the vehicle has been detected from an image of outside the vehicle (for example, in front of the vehicle M) captured by the camera 40 as illustrated in FIG. 12 for example. Moreover, when it has been detected that the vehicle M is vibrating and the vibrations continue for a specific time or greater, the state prediction section 154 may predict that a state unsuitable for the driver of the vehicle M to drive will arise.

The switching section 156 performs control to switch from manual driving to automated driving based on switching instructions due to the prediction result of the state prediction section 154 described above. For example, when a rut in the road outside the vehicle has been detected from an image of outside the vehicle captured by the camera 40 as described above, the switching section 156 may reference the driving switch information 188 as illustrated in FIG. 12 and perform control to switch from manual driving to automated driving 3 seconds prior to the vehicle M passing the rut. Moreover, automated driving using the switching control described above may, for example, be comparatively simple driving support such as lane-keep (lane keeping travel) or fixed speed travel of the vehicle M.

Switches in driving mode due to the switching control described above may cause control such that the original driving mode is temporarily returned to (switching to a drive mode with a low level of automated control) in cases in which a state unsuitable for the driver to drive has arisen. For example, the switch controller 150 may perform control to return from the automated driving mode to the original manual driving mode in cases in which a specific condition is satisfied after having switched the driving mode of the vehicle M from the manual driving mode to the automated driving mode, using the switching control described above. Note that the specific condition may, for example, be set in the driving switch information 188 described above.

For example, the detection section 152 continuously detects changes to the surrounding environment of the driver even after having switched from the manual driving mode to the automated driving mode. When it has been inferred that the driver of the vehicle M is in a state fit for driving (a posture enabling driving) from the images captured by the in-cabin camera 95, the detection section 152 outputs, to the state prediction section 154, information related to the inferred result. Note that a posture enabling driving is, for example, a state in which the driver of the vehicle M is grasping the steering wheel 78 while looking ahead of the vehicle M, and is causing the accelerator pedal 71 or the brake pedal 74 to be pushed down by a specific pedal-press amount.

The state prediction section 154 references the driving switch information 188 described above, and acquires the drive switching condition corresponding to the driving mode (self) and the surrounding environment of the driver (vehicle occupant in a posture enabling driving), based on the detection result made by the detection section 152. Here, in the driving switch information 188, a state in which manual driving is possible is set in cases in which a posture enabling driving continues for 3 seconds or more. Accordingly, when the above condition has been satisfied, the state prediction section 154 outputs, to the switching section 156, information (a switching instruction) for a switch from the automated driving mode to the manual driving mode. Note that when a posture enabling driving has not continued for 3 seconds or more, the state prediction section 154 does not issue a switching instruction to the switching section 156 since the switching condition has not been satisfied.

The switching section 156 implements control to switch from the automated driving mode to the manual driving mode and outputs, to the HMI controller 170, information regarding the switch from the automated driving mode to the manual driving mode.

Here, the switching section 156 may, for example, implement control to switch from the automated driving mode to the manual driving mode after a specific time (for example, from approximately 3 minutes to approximately 10 minutes) has elapsed since the switch from the manual driving mode to the automated driving mode. In such cases also, the switching section 156 outputs, to the HMI controller 170, information regarding the switch from the automated driving mode to the manual driving mode.

Moreover, after having switched from the manual driving mode to the automated driving mode, the switching section 156 may, for example, implement control to switch from the automated driving mode to the manual driving mode in cases in which an operation to switch from the automated driving mode to the manual driving mode has been received from the automated driving switching switch 87A of the HMI 70. In such cases also, the switching section 156 outputs, to the HMI controller 170, information regarding the switch from the automated driving mode to the manual driving mode.

Note that although receiving ah operation to switch from manual driving to automated driving from the automated driving switching switch 87A described above enables the driving to be switched, the driver of the vehicle M does not consciously perform switching operations on the drive mode in the present exemplary embodiment, and a switch to a drive mode with a high level of automated control can be made automatically from the surrounding environment of the driver and the like. Note that some or all of the examples of switching control described above may be combined.

The switch controller 150 may switch from the automated driving mode to the manual driving mode based on operations on the configuration of the driving operation system of the HMI 70 instructing acceleration, deceleration, or steering. For example, the switch controller 150 switches from the automated driving mode to the manual driving mode (overrides) in cases in which a state, in which an operation amount indicating input of a signal from configuration of the driving operation system of the HMI 70 exceeding a threshold value has continued for a reference time or more. The switch controller 150 may restore the automated driving mode in cases in which operation on the configuration of the driving operation system of the HMI 70 has not been detected during a specific time after switching to the manual driving mode due to override.

The travelling controller 160 controls the travel drive output device 200, the steering device 210, and the brake device 220 such that the vehicle M passes through the travelling course generated (scheduled) by the course generation section 146 in accordance with expected times.

When information regarding a switch in the driving mode has been input to the HMI controller 170 by the automated driving controller 120, the HMI controller 170 outputs the input information to the HMI 70 or the like. The HMI controller 170 also outputs information acquired by respective devices (onboard equipment) of the HMI 70 to the automated driving controller 120.

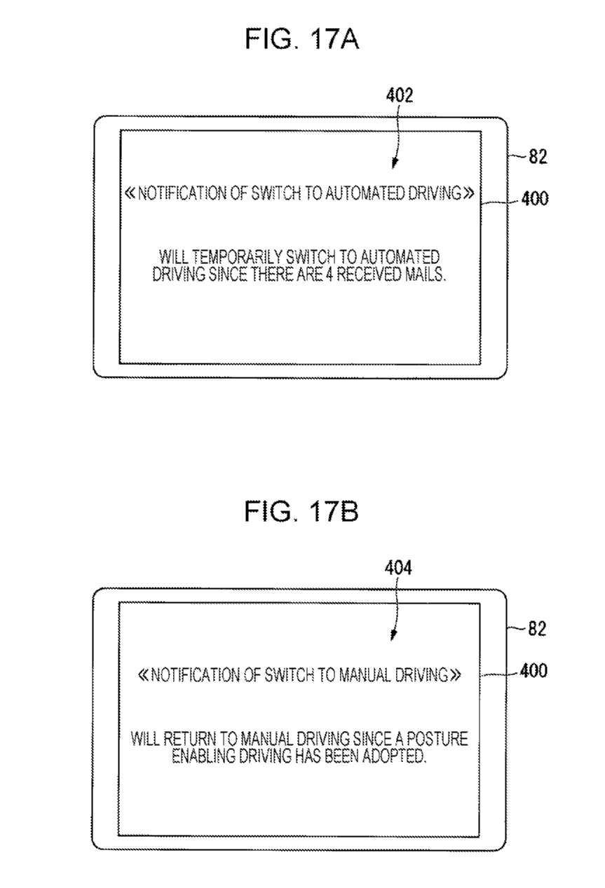

Here, FIG. 17A and FIG. 17B are diagrams illustrating examples of information output to the HMI 70. Note that although the display device 82 is given as an example of an output section in FIG. 17A and FIG. 17B, output may be made to, for example, the navigation device 50 or the like, and output may be made as audio via the speaker 83. The example of FIG. 17A illustrates a screen example in a case in which the driving mode has switched to a driving mode with a high level of automated control, and FIG. 17B illustrates a screen example in a case in which the driving mode has switched to a driving mode with a low level of automated control.

For example, in cases in which the switch controller 150 described above has caused a switch from the manual driving mode to the automated driving mode due to a condition set by the driving switch information 188 being satisfied, the HMI controller 170 outputs notification information 402 indicating that control to switch from manual driving to automated driving will be performed on a screen 400 of the display device 82, as illustrated in FIG. 17A. Note that the notification information 402 may notify that the switch from the manual driving mode to the automated driving mode is temporary driving support (assistance).

The notification information 402 may, for example, be acquired based on respective processing results and the like from the detection section 152 and the state prediction section 154. For example, in the example of FIG. 17A, “Will temporarily switch to automated driving since there are four received emails.” is displayed as the notification information 402 representing notification of a switch to automated driving; however, displayed content is not limited thereto. Notifying with information like that illustrated in FIG. 17A can cause the driver to ascertain that the vehicle M has switched to a driving mode with a high level of automated control, prior to a state unsuitable for the driver to drive arising. Moreover, the driver of the vehicle M can easily ascertain that the driving mode will temporarily switch, and the reason for the switch. Since the fact that the switch in the driving mode is temporary can be ascertained by the driver, the driver can be caused to swiftly respond to changes in the surrounding environment.

In cases in which the a condition set by the driving switch information 188 has been satisfied by the switch controller 150, or in cases in which a specific time has elapsed since switching to automated driving, the HMI controller 170 outputs, on the screen 400 of the display device 82, notification information 404 regarding the control that switches from the automated driving mode to the manual driving mode, as illustrated in FIG. 17B. For example, in the example of FIG. 17B, “Will return to manual driving since a posture enabling driving has been adopted.” is displayed as the notification information 404 representing a notification of the switch to manual driving; however, the contents are not limited thereto. The driver can be caused to ascertain that the vehicle M will switch to a driving mode with a low level of automated control by notifying with information like that illustrated in FIG. 17B. The driver of the vehicle M can easily ascertain the reason why the driving mode will switch.

When the HMI controller 170 is notified with information regarding a driving mode by the automated driving controller 120, the HMI controller 170 may control the HMI 70 in accordance with the type (manual driving mode, automated driving mode (mode A to mode C)) of driving mode.

### Processing Flow

Explanation follows regarding switch control processing in the vehicle control system 100 of the present exemplary embodiment, with reference to a flowchart. Note that in the following explanation, explanation is given in which control of switching between the manual driving mode and an automated driving mode (mode A) serves as an example of driving mode switching control; however, there is no limitation thereto and, for example, this may be control of switching between mode A and mode C of the automated driving or the like.

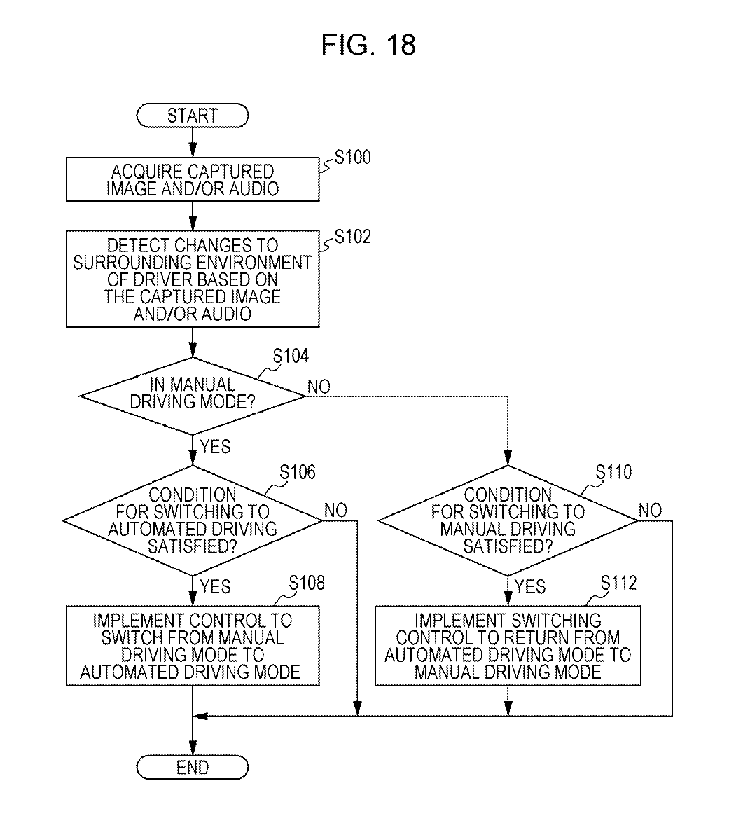

FIG. 18 is a flowchart illustrating an example of switch control processing. In the example of FIG. 18, the detection section 152 of the switch controller 150 acquires captured images, or audio, or both, from inside the vehicle M and outside the vehicle (step S100). In the processing of step S100, captured images may, for example, be continuously acquired using the camera 40 or the in-cabin camera 95, and audio information from inside the vehicle or outside the vehicle may, for example, be continuously acquired by the microphone 96.

Next, the detection section 152 detects changes to the surrounding environment of the driver based on the captured images or audio (step S102). Next, the state prediction section 154 of the switch controller 150 determines whether or not the current driving mode of the vehicle M is the manual driving mode (step S104). Note that in the processing of step S104, the state prediction section 154 determines that the driving mode is the automated driving mode (mode A) in cases in which the driving mode is not the manual driving mode.

In cases in which the current driving mode of the vehicle M is the manual driving mode, the state prediction section 154 references the driving switch information 188, and determines whether or not a condition for switching to the automated driving mode (a drive switching condition) is satisfied (step S106). In cases in which a condition for switching to automated driving is satisfied, the switching section 156 of the switch controller 150 implements control to switch from the manual driving mode to the automated driving mode, and the current flowchart reaches the end (step S108). Note that in the processing of step S108, the HMI controller 170 may output, to an output section of the display device 82 or the like, the fact that the switching control is to foe implemented. In cases in which a condition for switching to automated driving is not satisfied, the switch controller 150 may reach the end of the current flowchart as-is.

In cases in which the current driving mode of the vehicle M is not the manual driving mode, the state prediction section 154 references the driving switch information 188, and determines whether or not a condition for switching to manual driving is satisfied (step S110). In cases in which a condition for switching to manual driving is satisfied, the switching section 156 implements control to return from automated driving to manual driving, and the current flowchart reaches the end (step S112). Note that in the processing of step S112, the HMI controller 170 may output, to an output section of the display device 82 or the like, the fact that the switching control will be implemented. In cases in which the conditions for switching to manual driving have not been satisfied, the switch controller 150 reaches the end of the current flowchart as-is.

Note that, in the processing of step S110 and step S112 described above, an example of processing is given in which the original manual driving mode is returned to based on a specific condition, after control to switch from the manual driving mode to the automated driving mode has been performed by the processing of step S108; however, examples of processing for returning to the manual driving mode are not limited thereto. For example, after a specific time has elapsed since control was performed to switch from the manual driving mode to the automated driving mode by the processing of step S108, the switch controller 150 may perform switching control to return to the manual driving mode, or may perform switching control to return to the manual driving mode from the automated driving mode in accordance with content received by an operation reception section or the like of the automated driving switching switch 87A or the like. The switch control processing according to the present exemplary embodiment described above is repeatedly executed at specific timings.

In the present exemplary embodiment described above, it is predicted that a state unsuitable for the driver to drive will arise based on changes to the surrounding environment of the driver of the vehicle M; however, the prediction method is not limited thereto. For example, the detection section 152 may also detect at least one out of the posture, behavior, operation content, line of sight direction, or the like of the driver, rather than changes to the surrounding environment of the driver alone. In such cases, the state prediction section 154 predicts that a state unsuitable for the driver to drive arising from the detection result described above.

According to the present exemplary embodiment described above, driving support can be implemented in a wider range of cases by switching to a driving mode with a high level of automated control in cases in which it is predicted that a state unsuitable for the driver of the vehicle M to drive will arise based on changes to the surrounding environment of the vehicle M. Moreover, the original driving mode (a driving mode with a low level of automated control) can easily be returned to in cases in which a state suitable for the driver of the vehicle M to drive has arisen.

Explanation has been given above regarding modes for implementing the present disclosure, with reference to embodiments; however, the present disclosure is not limited to such embodiments in any way, and various modifications and substitutions may be applied within a range not departing from the spirit of the present disclosure.

What is claimed is:

1. A vehicle control system, comprising:
a driving controller configured to switch a driving mode to either
automated driving in any one of a plurality of driving modes having different levels of automated control, in which driving support is performed for at least one out of speed control or steering control of a vehicle, or
manual driving performed based on operations of a driver of the vehicle on both the speed control and the steering control of the vehicle;
a detection section configured to detect a change to a surrounding environment of the driver;
a state prediction section configured to predict that a state unsuitable for the driver to drive will arise based on the change to the surrounding environment detected by the detection section; and
a switching section configured to switch a first driving mode being implemented by the driving controller to a second driving mode with a high level of automated control in cases in which the state unsuitable for the driver to drive is predicted to arise by the state prediction section, the level of automated control in the second driving mode being higher than a level of automated control in the first driving mode.

2. The vehicle control system according to claim 1, further comprising:
an imaging section configured to capture an image inside the vehicle; and
an audio acquisition section configured to acquire sound from inside the vehicle or from outside the vehicle, wherein,
the detection section detects the change to the surrounding environment of the driver based on either or both of the image captured by the imaging section and the sound acquired by the audio acquisition section.

3. The vehicle control system according to claim 1, wherein
the state prediction section is configured to obtain a change in a vehicle interior environment, a vehicle exterior environment or an onboard equipment state of the vehicle as the change in the surrounding environment, and to predict that the state unsuitable for the driver to drive will arise in cases in which the change in at least one out of the vehicle interior environment, the vehicle exterior environment, or the onboard equipment state of the vehicle satisfies a predetermined condition.

4. The vehicle control system according to claim 1, wherein
the switching section further switches the second driving mode of the vehicle to a third driving mode with a low level of automated control in cases in which it is inferred that the driver is in a posture enabling driving of the vehicle after the switching from the first driving mode of the vehicle to the second driving mode with the high level of automated control, the level of automated control in the third driving mode being lower than the level of automated control in the second driving mode.

5. The vehicle control system according to claim 1, wherein
the switching section further switches the second driving mode of the vehicle to a third driving mode with a low level of automated control when a specific time has elapsed since the switching to the second driving mode with the high level of automated control, the level of automated control in the third driving mode being lower than the level of automated control in the second driving mode.

6. The vehicle control system according to claim 1, further comprising:
an operation reception section configured to detect an operation by the driver -which switches the driving mode, wherein,
after the switching from the first driving mode of the vehicle to the second driving mode with the high level of automated control, the switching section further switches the second driving mode of the vehicle to a third driving mode with a low level of automated control on the detection of the driver's operation that switches to the third driving mode with the low level of automated control which is lower than the level of automated control in the second driving mode.

7. The vehicle control system according to claim 1, wherein
the state prediction section predicts the state unsuitable for the driver to drive based on at least one out of receipt of a message for the driver, a specific operation on onboard equipment, a state of an object inside the vehicle, a state of an occupant other than the driver of the vehicle, or a state of surroundings of the vehicle.

8. The vehicle control system according to claim 1, further comprising:
an output section configured to output information regarding the driving mode; and
an interface controller configured to, in cases in which the state unsuitable for the driver to drive is predicted to arise by the state prediction section and the first driving mode being implemented by the driving controller is switched to the second driving mode with the high level of automated control, cause the output section to output information indicating the switching to the second driving mode with the high level of automated control.

9. The vehicle control system according to claim 1, further comprising:
an output section configured to output information regarding the driving mode; and
an interface controller configured to, in cases in which the state unsuitable for the driver to drive is predicted to arise by the state prediction section and the first driving mode being implemented by the driving controller is switched to the second driving mode with the high level of automated control, cause the output section to output information indicating that the implementation of the second driving mode with the high level of automated control is temporary.
10. A vehicle control method performed by an onboard computer, comprising:
controlling to switch a drive mode to either
automated driving In. any one of a plurality of driving modes having different levels of automated control, in which driving support is performed for at least one out of speed control or steering control of a vehicle, or
manual driving performed based on operations of a driver of the vehicle on both the speed control and the steering control of the vehicle;
detecting a change to a surrounding environment of the driver;
predicting that a state unsuitable for the driver to drive will arise based on the detected change to the surrounding environment; and
switching the driving mode from a first driving mode being implemented to a second driving mode with a high level of automated control in cases in which the state unsuitable for the driver to drive is predicted to arise, the level of automated control in the second driving mode being higher than a level of automated control in the first driving mode.

11. A vehicle control program executable by an onboard computer, to perform:
controlling to switch a driving mode to either
automated driving in any one of a plurality of driving modes having different levels of automated control, in which driving support is performed for at least one out of speed control or steering control of a vehicle, or
manual driving performed based on operations of a driver of the vehicle on both the speed control and the steering control of the vehicle;
detecting a change to a surrounding environment of the driver;
predicting that a state unsuitable for the driver to drive will arise based on the detected change to the surrounding environment; and
switching the driving mode from a first driving mode being implemented to a second driving mode with a high level of automated control in cases in which a state unsuitable for the driver to drive has been predicted to arise, the level of automated control in the second driving mode being higher than a level of automated control in the first driving mode.
